(19) United States
(12) Patent Application Publication
(10) Pub. No.: US 2024/0356723 A1
(43) Pub. Date: Oct. 24, 2024

(54) System and method for implementing an interaction session with an entity using intermediate devices and homomorphic encryption

(71) Applicant: Bank of America Corporation, Charlotte, NC (US)

(72) Inventor: Shailendra Singh, Thane West (IN)

(21) Appl. No.: 18/302,565

(22) Filed: Apr. 18, 2023

(51) Int. Cl. H04L 9/00

(52) U.S. Cl. CPC H04L 9/008; H04L 9/50

(57) ABSTRACT

A system for implementing an interaction session with an entity using intermediate equipment and homomorphic encryption comprises a first communication equipment and a second communication equipment in communication with an entity server via a network. The first communication equipment is communicatively coupled to the second communication equipment via a short-range wireless connection. The first communication equipment communicates an encrypted interaction payload to the second communication equipment which forwards the encrypted interaction payload to an entity server. The entity server sends an encrypted validation message including a security code to the first communication equipment through the second communication equipment to validate an interaction payload object. The first communication equipment receives a user input and communicates an encrypted user input to the second communication equipment which forwards the encrypted user input to the entity server. The entity server determines that the user input comprises the security code and reconciles the payload object.

### TECHNICAL FIELD

The present disclosure relates generally to network communications and network security, and more specifically to a system and method for implementing an interaction session with an entity using intermediate equipment and homomorphic encryption.

### BACKGROUND

A user may generally use a computing equipment (e.g., mobile phone) to complete an interaction session with an entity directly. In some scenarios, the computing equipment associated with the user is not connected to an internet or network. Conventional technologies are not configured to provide a secure and efficient solution to facilitate completing the interaction session for the user with the computing equipment which is not connected to the network.

### SUMMARY

In a conventional system, a user usually communicates with an entity to send an interaction payload using a user communication equipment via a network. When the user communication equipment associated with the user is not connected to the network, the user may not be able to communicate with the entity. Accordingly, pursuant to the present disclosure, the user communication equipment pairs with an intermediate equipment or a third party equipment to send the interaction payload to an entity. However, it may not be secure to directly send the interaction payload through the intermediate equipment to the entity. Further, the entity may validate the interaction payload with the user through the intermediate equipment. The present system addresses this issue by using one or more intermediate equipment and homomorphic encryption to securely implement an interaction session for sending the interaction payload to the entity for the user. For example, a first communication equipment associated with a first user may request to pair with an intermediate equipment (e.g., a second communication equipment) located in an area of a short-range wireless connection. The first communication equipment may transfer an encrypted interaction payload through the second communication equipment via the short-range wireless connection. Because the system uses homomorphic encryption, the second communication equipment may directly pass the encrypted interaction payload to an entity server via the network without decrypting the encrypted interaction payload. The entity server may validate the encrypted interaction payload by transferring an encrypted validation message including a security code to the first communication equipment through the second communication equipment via the network. The first communication equipment may validate the interaction payload by sending an encrypted user input including the security code via the short-range wireless connection through the second communication equipment to the entity server. The entity server may validate the interaction payload by determining that the security code received from the encrypted user is the security code included in the encrypted validation message. Further, the entity server may reconcile a payload object of the interaction payload for the user.

In one embodiment, a system for implementing an interaction session with an entity using intermediate equipment and homomorphic encryption comprises a first communication equipment associated with a first user and a second communication equipment in communication with an entity server via a network. The first communication equipment is communicatively coupled to the second communication equipment via a short-range wireless connection. The first communication equipment initiates an interaction session associated with an interaction payload with a second communication equipment. The interaction payload comprises a payload metadata and a payload instruction to send a payload object to an entity. The interaction payload is encrypted as an encrypted interaction payload by the first communication equipment. The first communication equipment communicates the encrypted interaction payload to the second communication equipment via the short-range wireless connection. The second communication equipment forwards the encrypted interaction payload to the entity server associated with the entity via the network. In response to receiving the encrypted interaction payload, the entity server sends an encrypted validation message to the first communication equipment through the second communication equipment. The encrypted validation message comprises a security code and is configured to validate the payload object associated with the interaction payload. The first communication equipment receives a user input to validate the payload object associated with the interaction payload in response to the encrypted validation message. The first communication equipment communicates to the second communication equipment an encrypted user input validating the payload object. The second communication equipment forwards the encrypted user input to the entity server through the network. The entity server determines the user input based on the encrypted user input. The entity server determines whether the user input comprises the security code. In response to determining that the user input comprises the security code, the entity server reconciles the payload object based on the payload instruction and the payload metadata to complete the interaction session.

The system described in the present disclosure is particularly integrated into a practical application that provides a secure and effective solution of implementing an interaction session with an entity using intermediate equipment and homomorphic encryption to transmit an interaction payload from a communication equipment which is not connected to a network. The practical application is implemented by transmitting the encrypted interaction payload and the encrypted user input from the first communication equipment to the entity server through an intermediate equipment via the short-range wireless connection. Further, the practical application is implemented by transmitting the encrypted validation message from the entity server through the intermediate equipment to the first communication equipment to validate the payload object associated with the interaction payload. The intermediate equipment may transfer various encrypted information between the first communication equipment and the entity server without decrypting the encrypted information. In this way, the practical application provides a secure and effective solution to transfer and validate the interaction payload before the entity server reconciles the payload object of the interaction payload for the user.

The practical application leads to technical advantages of improving a process of securely sending the interaction payload to the entity using one or more intermediate equipment for a user who has a communication equipment which is not connected to a network. The practical application may effectively prevent bad actors from gaining unauthorized access to information including an interaction payload information, an interaction payload validation message and a user input through unauthorized intermediate equipment or emulated messages in the network. The disclosed system may further improve network security between computer systems of a computer network and improve information security.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement an interaction session with an entity using intermediate equipment and homomorphic encryption;

FIG. 2 illustrates an example diagram with an example dynamic hopping chain to implement an interaction session with an entity using intermediate equipment and homomorphic encryption; and

FIG. 3 illustrates an example operational flow of a method for implementing an interaction session with an entity using intermediate equipment and homomorphic encryption.

### DETAILED DESCRIPTION

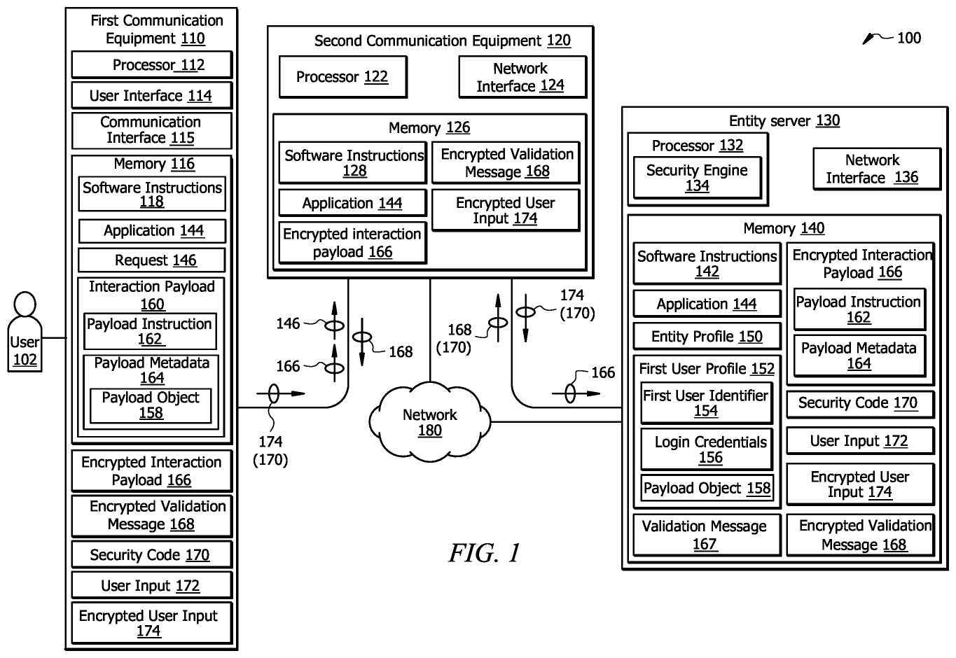

Previous technologies fail to provide a secure and efficient solution to implement an interaction session with an entity using intermediate equipment or third party equipment for a user who has a communication equipment which is not connected to a network. This disclosure presents a system for implementing an interaction session with an entity using intermediate equipment and homomorphic encryption by referring to FIGS. 1-3.

### System Overview

FIG. 1 illustrates one embodiment of a system 100 that is configured to implement an interaction session with an entity using intermediate equipment and homomorphic encryption. In some embodiments, system 100 comprises a first communication equipment 110, a second communication equipment 120, an entity server 130, and a network 180. Network 180 enables the communication between components of the system 100. Entity server 130 comprises a processor 132 in signal communication with a memory 140. Memory 140 stores software instructions 142 that when executed by the entity server 130, cause the entity server 130 to execute one or more functions described herein. For example, when the software instructions 142 are executed, the entity server 130 executes a security engine 134 to perform operations illustrated in FIGS. 1-3.

The first communication equipment 110 associated with a user 102 comprises a processor 112 in signal communication with a memory 116. Memory 116 stores software instructions 118 that when executed by the first communication equipment 110, cause the first communication equipment 110 to perform operations illustrated in FIGS. 1-3. The second communication equipment 120 is an intermediate equipment or third party communication equipment which comprises a processor 122 in signal communication with a memory 126. Memory 126 stores software instructions 128 that when executed by the second communication equipment 120, cause the second communication equipment 120 to perform operations illustrated in FIGS. 1-3. An application 144 with a homomorphic encryption algorithm may be a common application installed on the entity server 130, the first communication equipment 110, the second communication equipment 120, and other intermediate equipment to implement the interaction session between the first user 102 and the entity. A homomorphic encryption algorithm is a secure computation algorithm which is used to perform mathematical operations over encrypted data without first decrypting the encrypted data. The homomorphic encryption algorithm may include multiple types of encryption schemes that can perform different computations or operations over the encrypted data without actually decrypting it. For example, a first user 102 with a first communication equipment 110 may want another communication equipment to perform some operations on the interaction payload without decrypting the encrypted interaction payload. Another communication equipment may process the encrypted interaction payload without actually presenting the data. Some common types of homomorphic encryption may be partially homomorphic encryption, somewhat homomorphic encryption, and fully homomorphic encryption. The application 144 may be implemented with one of any types of the homomorphic encryption algorithms. In other embodiments, system 100 may not have all the components listed and/or may have other elements instead of, or in addition to, those listed above.

In some embodiments, a first user 102 may want to use a first communication equipment 110 to send an interaction payload 160 to the entity server 130 through the network 180, but the first communication equipment 110 associated with the first user 102 may not be connected to a network 180. The first user 102 may use the first communication equipment 110 to pair with the second communication equipment 120 located in an area of the short-range wireless connection that is separate from communications offered by network 180. For example, the first communication equipment 110 may transfer an encrypted interaction payload 166 to the second communication equipment 120 via the short-range wireless connection. The second communication equipment 120 may then communicate the encrypted interaction payload 166 to an entity server 130 on behalf of first communication equipment 110, via network 180. The entity server 130 may validate the payload object 158 associated with the interaction payload 160 by transferring an encrypted validation message 168 including a security code 170 to the first communication equipment 110 through the second communication equipment 120. The first communication equipment 110 may validate the payload object 158 associated with the interaction payload 160 by sending an encrypted user input 174 including the security code 170 through the second communication equipment 120 to the entity server 130. The entity server 130 may identify the security code 170 from the encrypted user input 174 and validate the payload object 158 of the interaction payload 160. The entity server 130 may reconcile a payload object 158 of the interaction payload 160 for the first user 102.

### System Components

### Network

Network 180 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 180 may be configured to support any suitable type of communication protocol as would be appreciated by one of ordinary skill in the art.

### Communication Equipment

As illustrated in FIG. 1, a first communication equipment 110 may be a computing equipment which is not connected to a network 180. In some embodiments, the first communication equipment 110 may be communicatively coupled to the second communication equipment 120 or other intermediate equipment via a short-range wireless connection, such as Near-field communication (NFC), Bluetooth, or any other type of short-range wireless connections.

Examples of the first communication equipment 110 include, but are not limited to, a personal computer, a desktop computer, a workstation, a server, a laptop, a tablet computer, a mobile phone (such as a smartphone), etc. The first communication equipment 110 may include a hardware processor 112, memory 116, and/or circuitry configured to perform any of the functions or actions of the first communication equipment 110 described herein. The processor 112 may include one or more processors operably coupled to and in signal communication with the memory 116, user interface 114, communication interface 115, and other components. The one or more processors 112 may be any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The one or more processors 112 may be a programmable logic device, a microcontroller, a microprocessor, or any suitable combination of the preceding. The one or more processors 112 may be configured to process data and be implemented in hardware or software. For example, the processor may be 8-bit, 16-bit, 32-bit, 64-bit, or of any other suitable architecture. The processor 112 may include an arithmetic logic unit (ALU) for performing arithmetic and logic operations. For example, one or more software applications designed using software code may be stored in the memory 116 and executed by the processor 112 to perform the functions of the first communication equipment 110.

In some embodiments, the memory 116 may store an application 144 with a homomorphic encryption algorithm. The application 144 may be software instructions, a mobile application, or a web application that is executed by processor 112 to implement various operations described herein. The application 144 may be associated with an organization entity that provides application services to users 102. The application 144 may be configured to register with the entity and create a first user profile 152 with login credentials 156 for a first user 102 associated with the first communication equipment 110. The first user 102 may operate the first communication equipment 110 to log in on the application 144 with the with login credentials 156 to access one or more application services provided by an entity server 130 associated with the entity. The memory 116 may store a request 146, an interaction payload 160, an encrypted interaction payload 166, an encrypted validation message 168, a security code 170, a user input 172, an encrypted user input 174, and/or any other data or instructions.

The user interface 114 may include a display, a microphone, keypad, or other appropriate terminal equipment usable by a first user 102. The communication interface 115 may be configured to use any suitable type of communication protocol and enable wired and/or wireless communications as would be appreciated by one of ordinary skill in the art.

### Intermediate Equipment

A second communication equipment 120 may represent an intermediate equipment which is in communication with the first communication equipment 110 via the short-range wireless connection. Meanwhile, the second communication equipment 120 is in communication with the entity server 130 via the network 180. Examples of the second communication equipment 120 include, but are not limited to, a personal computer, a desktop computer, a workstation, a server, a laptop, a tablet computer, a mobile phone (such as a smartphone), etc.

The second communication equipment 120 may include a hardware processor 122, memory 126, and/or circuitry configured to perform any of the functions or actions of the second communication equipment 120 described herein. The processor 122 may include one or more processors operably coupled to and in signal communication with the memory 126, network interface 124, and other components. The one or more processors 122 may be any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The one or more processors 122 may be a programmable logic device, a microcontroller, a microprocessor, or any suitable combination of the preceding. The one or more processors 122 may be configured to process data and be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations. For example, one or more software applications designed using software code may be stored in the memory 126 and executed by the processor 122 to perform the functions of the second communication equipment 120.

In some embodiments, the memory 126 may store an application 144 with a homomorphic encryption algorithm. The application 144 may be software instructions, a mobile application, or a web application that is executed by the processor 122 to access one or more application services provided by the entity server 130 and implement various operations described herein. The memory 126 may store an encrypted interaction payload 166, an encrypted validation message 168, an encrypted user input 174, and/or any other data or instructions.

The network interface 124 may be configured to use any suitable type of communication protocol and enable wired and/or wireless communications as would be appreciated by one of ordinary skill in the art.

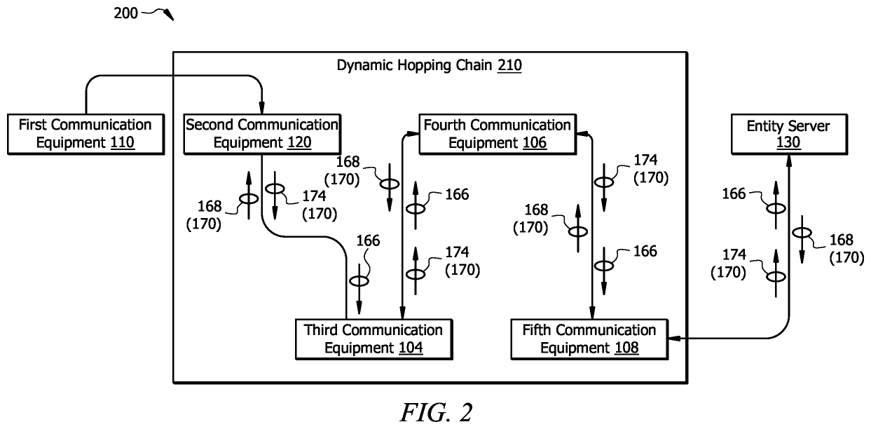

FIG. 2 illustrates an example diagram 200 with an example dynamic hopping chain 210 to implement an interaction session with an entity server 130 associated with an entity. The example dynamic hopping chain 210 may include a plurality of intermediate equipment, such as a second communication equipment 120, a third communication equipment 104, a fourth communication equipment 106, and a fifth communication equipment 108. The application 144 may be installed on each intermediate equipment with homomorphic encryption. The one or more intermediate equipment along the dynamic hopping chain 210 may be used to implement the processes and embodiments described below.

### Entity Server

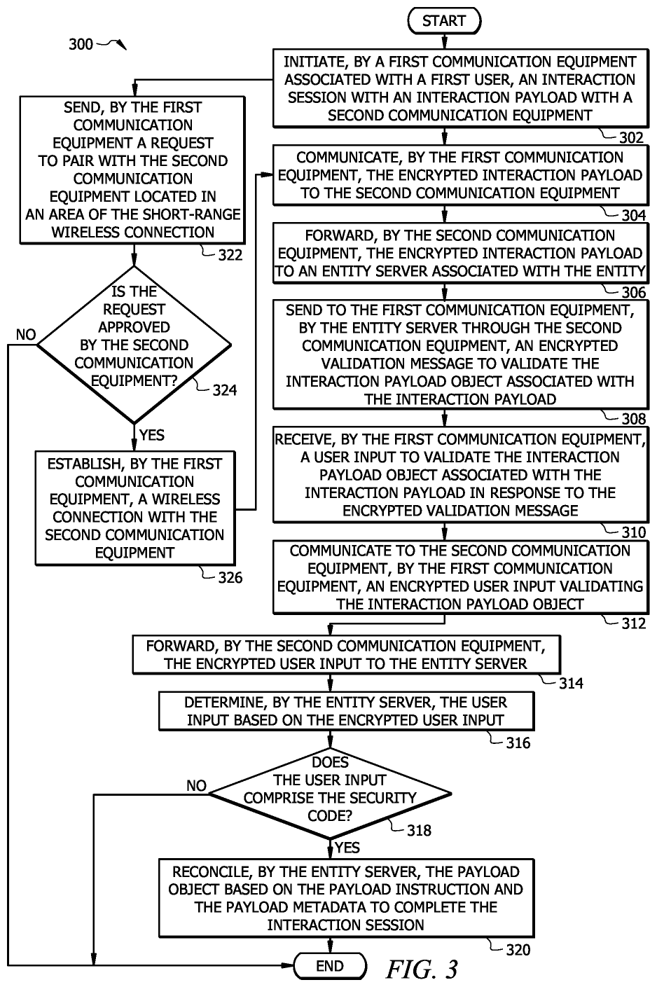

Entity server 130 is generally a server, or any other equipment configured to process data and communicate with the second communication equipment 120 via the network 180. The entity server 130 is generally configured to execute the operations of the security engine 134, as described further below in conjunction with operational flow of the method 300 described in FIG. 3. The entity server 130 may be a central server implemented in the cloud or, alternatively, it may be organized in a distributed manner.

Entity server 130 comprises one or more processors 132 operably coupled to the memory 140. The entity server 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 132 may be a programmable logic device, a microcontroller, a microprocessor, or any suitable combination of the preceding. The one or more processors are configured to process data and may be implemented in hardware or software. For example, the processor 132 may be 8-bit, 16-bit, 32-bit, 64-bit, or of any other suitable architecture. The processor 132 may include an arithmetic logic unit (ALU) for performing arithmetic and logic operations. The processor 132 registers the supply operands to the ALU and store the results of ALU operations, and a control unit that fetches instructions from memory 140 and executes them by directing the coordinated operations of the ALU, registers and other components. The one or more processors are configured to implement various instructions. For example, the one or more processors are configured to execute instructions (e.g., software instructions 142) to implement the security engine 134 and/or to execute one or more operations described herein with respect to entity server 130. In this way, the processor 132 may be a special-purpose computer designed to implement the functions disclosed herein. In one embodiment, the processor 132 is implemented using logic units, FPGAs, ASICs, DSPs, or any other suitable hardware. The processor 132 is configured to operate to execute the security engine 134 to perform one or more operations as described in FIG. 3.

Memory 140 may be volatile or non-volatile and may comprise a read-only memory (ROM), random-access memory (RAM), ternary content-addressable memory (TCAM), dynamic random-access memory (DRAM), and static random-access memory (SRAM). Memory 140 may be implemented using one or more disks, tape drives, solid-state drives, and/or the like. The memory 140 is operable to store the software instructions 142 and/or any other data or instructions. The software instructions 142 may store any suitable set of instructions, logic, rules, or code operable to be executed by the processor 132 to implement the processes and embodiments described below. In an example operation, the memory 140 may store an application 144, a homomorphic encryption algorithm and other program modules which are implemented by processor 132 in computer-executable software instructions, such as software instructions 142. In some embodiments, the application 144 may include the homomorphic encryption algorithm to process data or perform computations on encrypted data without decrypting the encrypted data. In some embodiments, a homomorphic encryption algorithm may be a fully homomorphic encryption which supports homomorphic operations such as addition and multiplication with no limit on the number of times they are performed on the encrypted data.

The memory 140 is operable to store an entity profile 150, a first user profile 152, an encrypted interaction payload 166, a validation message 167, an encrypted validation message 168, a security code 170, a user input 172, an encrypted user input 174, and/or any other data or instructions. The entity profile 150 may include entity information, such as an entity identifier, entity phone number, entity email address, entity name, and entity weblink, and any other data associated with the entity. The first user 102 may register a first user profile 152 with the entity through the entity server 130 to use one or more application services provided by the entity. The first user profile 152 may be user information including a first user identifier 154 and login credentials 156, and a payload object 158. The first user identifier 154 may include one of user phone number, user email address, user name, and any other data associated with the user. The validation message 167 and the encrypted validation message 168 may include the security code 170. The user input 172 and the encrypted user input 174 may include the security code 170 the user entered through the first communication equipment 110 to validate the payload object 158 associated with the interaction payload 160. For example, the security code 170 may be a n-digit-token which comprises a series of security digits.

The memory 140 may store the application 144 associated with the entity that provides application services to users 102. The application 144 may be software instructions, a mobile application, or a web application that is executed by processor 132 to implement various operations described herein. For example, the application 144 may validate the first user identity based on the login credentials 156 stored in a memory 140. If the first user identity is validated, the first user 102 may access the application 144 for an application service provided by the entity. In some embodiments, the entity server 130 may be configured to use the application 144 with a homomorphic encryption algorithm to evaluate an encrypted interaction payload 166 which is received from the second communication equipment 120 and associated with the first user 102.

Network interface 136 is configured to enable wired and/or wireless communications (e.g., via network 180). The network interface 136 is configured to communicate data between the entity server 130 and other intermediate equipment such as a second communication equipment 120, databases, systems, or domains. For example, the network interface 136 may comprise a WIFI interface, a local area network (LAN) interface, a wide area network (WAN) interface, a modem, a switch, or a router. The processor 132 is configured to send and receive data using the network interface 136. The network interface 136 may be configured to use any suitable type of communication protocol as would be appreciated by one of ordinary skill in the art.

### Security Engine

In some embodiments, a first communication equipment 110 associated with a first user 102 may not connected to the network 180. The first user 102 may operate the first communication equipment 110 to send an interaction payload 160 to the entity associated with the entity server 130. The first communication equipment 110 may pair with the second communication equipment 120 or another intermediate equipment located in an area of the short-range wireless connection. For example, the first communication equipment 110 may transfer an encrypted interaction payload 166 to the second communication equipment 120 via the short-range wireless connection. The second communication equipment 120 may communicate the encrypted interaction payload 166 to the entity server 130 through the network 180.

In some embodiments, a security engine 134 of the entity server 130 may be implemented by the processor 132 to execute the software instructions 142 to receive the encrypted interaction payload 166 from the second communication equipment 120 or another intermediate equipment via the network 180. The security engine 134 of the entity server 130 may be implemented by the processor 132 to execute the application 144 to send an encrypted validation message 168 to the second communication equipment 120 to validate the payload object 158 associated with the interaction payload 160. The encrypted validation message 168 includes a security code 170 generated by entity server 130. The first communication equipment 110 may send an encrypted user input 174 to the second communication equipment 120 in response to receiving the encrypted validation message 168 from the second communication equipment 120 through the short-range wireless connection. The entity server 130 may receive the encrypted user input 174 from the second communication equipment 120 through the network 180. The security engine 134 of the entity server 130 may be implemented by the processor 132 to execute the application 144 to determine that the encrypted user input 174 includes the security code 170 and validate the payload object 158 associated with the interaction payload 160 from the first user 102. Further, the security engine 134 of the entity server 130 may be implemented by the processor 132 by executing the software instructions 142 to reconcile the payload object 158 and send the payload object 158 to a third party server as requested by the first user 102.

### Initiate an Interaction Session for Sending an Interaction Payload

In some embodiments, an application 144 may be a common application installed on the first communication equipment 110, the second communication equipment 120, and the entity server 130 of the system 100 as illustrated in FIG. 1. The application 144 may be configured to be executed by the processor 132 of the entity server 130 to implement homomorphic encryption. The first user 102 may use the first communication equipment 110 to pair with the second communication equipment 120 located in an area of the short-range wireless connection. The first communication equipment 110 may execute the application 144 presented on the user interface 114 to communicate with multiple intermediate equipment in an area of the short-range wireless connection. The first communication equipment 110 and the multiple intermediate equipment are installed with the application 144 to use one or more application services provided by an entity. For example, the first user 102 may send a request 146 to pair with an intermediate equipment such as the second communication equipment 120 in area of the short-range wireless connection. The second communication equipment 120 may execute the application 144 to display the request 146 from the first communication equipment 110 and decide whether to approval the request 146. After receiving an approval of the request 146 from the second communication equipment 120, the first communication equipment 110 may execute the application 144 to initiate an interaction session with the second communication equipment 120 for requesting the entity to send an interaction payload 160 to a third party server. The interaction payload 160 may comprise a payload instruction 162 and a payload metadata 164 to send a payload object 158 to the entity server 130 associated with an entity. The payload metadata 164 of the interaction payload 160 may comprise the payload object 158, a first user identifier 154, a first user location, and entity information. The payload object 158 may be stored in a first user profile 152 and associated with the first user identifier 154. The first user profile 152 of the first user 102 may include information that the first user 102 registers with the entity. The first user profile 152 may be stored in the memory 140 of the entity sever 130 and include a first user identifier 154, login credentials 156, and a payload object 158. The payload object 158 may be a digital item associated with the first user 102 and the first user profile 152, etc. For example, the digital item may be a digital value or an electronic document associated with one or more application services provided by the entity. The payload instruction 162 of the interaction payload 160 may represent a payload request that the first user 102 requests the entity to send the payload object 158 from the first user profile 152 to a thirty party server. The thirty party server may be associated with a third party, such as a merchant or a thirty party user.

### Send an Interaction Payload to an Entity Through One or More Intermediate Equipment

In some embodiments, the first communication equipment 110 may execute the application 144 with the homomorphic encryption algorithm to encrypt the interaction payload 160 as an encrypted interaction payload 166. The first communication equipment 110 may communicate the encrypted interaction payload 166 to the second communication equipment 120 via the short-range wireless connection. In some embodiments, the system 100 may include a plurality of intermediate equipment from which the first user 102 may choose an intermediate equipment to pair with via the short-range wireless connection. FIG. 2 illustrates an example dynamic hopping chain 210 to implement an interaction session with an entity associated with an entity server 130 using multiple intermediate equipment and homomorphic encryption in the system 100. The dynamic hopping chain 210 may be established based on an availability and a location of each intermediate equipment as illustrated in FIG. 2. In some embodiments, the second communication equipment 120 may be one of a plurality of intermediate equipment associated with the example dynamic hopping chain 210.

As illustrated in FIG. 2, the multiple intermediate equipment of the example dynamic hopping chain 210 may include a second communication equipment 120, a third communication equipment 104, a fourth communication equipment 106, and a fifth communication equipment 108 (or any suitable number of fewer or additional intermediate equipment). Each intermediate equipment along the dynamic hopping chain 210 may be installed with the application 144 with the homomorphic encryption algorithm to transfer encryption data. For example, the first communication equipment 110 at a first geographical location may pair with the second communication equipment 120 at a second geographical location via the short-range wireless connection. The first communication equipment 110 may communicate the encrypted interaction payload 166 to the second communication equipment 120 via the short-range wireless connection. The second communication equipment 120, a third communication equipment 104, a fourth communication equipment 106, and a fifth communication equipment 108 may pair with or communicate with each other along the dynamic hopping chain 210 via the short-range wireless connection or the network 180 to transmit the encrypted interaction payload 166 to the entity server 130 along the dynamic hopping chain 210.

In some embodiments, the dynamic hopping chain 210 may be used to transmit the encrypted interaction payload 166 from the first communication equipment 110 through the intermediate equipment 120, 104, 106, and 108 to the entity server 130. For example, the second communication equipment 120, a third communication equipment 104, a fourth communication equipment 106, and a fifth communication equipment 108 may located at different geographical locations. The second communication equipment 120, the third communication equipment 104, the fourth communication equipment 106, and the fifth communication equipment 108 may connect with each other to establish dynamic hopping chain 210 via the short-range wireless connection or the network 180. The second communication equipment 120 paired with the first communication equipment 110 may execute the application 144 to identify that the third communication equipment 104 is available at the third geographical location. The second communication equipment 120 may automatically connect to the third communication equipment 104 via the short-range wireless connection or the network 180. Similarly, the third communication equipment 104 may execute the application 144 to automatically identify the fourth communication equipment 106 available at the fourth geographical location and automatically connect to the fourth communication equipment 106 via the short-range wireless connection or the network 180. The fourth communication equipment 106 may execute the application 144 to automatically identify the fifth communication equipment 108 available at the fifth geographical location and automatically connect to the fifth communication equipment 108 via the short-range wireless connection or the network 180.

In some embodiments, the dynamic hopping chain 210 may be used to transmit the encrypted validation message 168 from the entity server 130 to the first communication equipment 110 through one or more intermediate equipment 108, 106, 104, and 120 for validating the payload object 158 associated with the interaction payload 160 with the first user 102. In one embodiment, the entity server 130 may determine that the encrypted interaction payload 166 is received from an intermediate equipment such as the fifth communication equipment 108 along the dynamic hopping chain 210. The entity server 130 may send the encrypted validation message 168 to the fifth communication equipment 108 via the network 180. When the fifth communication equipment 108 receives the encrypted validation message 168 from the entity server 130, the fifth communication equipment 108 may execute the application 144 to forward the encrypted validation message 168 to the fourth communication equipment 106 via the short-range wireless connection or the network 180. The encrypted validation message 168 may be forwarded to the first communication equipment 110 though one or more intermediate equipment along the dynamic hopping chain 210. Further, the dynamic hopping chain 210 may be used to transmit the encrypted user input 174 from the first communication equipment 110 through one or more intermediate equipment 120, 104, 106, and 108 to the entity server 130 along the dynamic hopping chain 210. The details are described in the processes and embodiments below.

### Validate the Interaction Payload

In some embodiments, in response to receiving the encrypted interaction payload 166 from the second communication equipment 120 or another intermediate equipment, the entity server 130 may execute the application 144 to validate the payload metadata 164 and the payload instruction 162 from the encrypted interaction payload 166 before reconciling the payload object 158. The entity server 130 may be executed by the processor 132 to determine whether the payload instruction 162 and the payload metadata 164 are associated with the first user 102 who registers with the entity server 130 for one or more services provided by the entity. For example, the entity server 130 may determine whether the payload metadata 164 matches the first user identifier 154 of a first user profile 152 stored in the memory 140 of the entity server 130. The entity server 130 may determine whether the payload metadata 164 comprises the payload object 158 associated with the first user identifier 154 of the first user profile 152.

The entity server 130 may execute the software instructions 142 to generate a security code 170 and a validation message 167. The security code 170 may be a random number and/or a random alphanumeric string. For example, the security code 170 may be a n-digit-token which comprises a series of security digits, such as a multi-factor authentication token. The security code 170 is associated with the validation message 167, entity information, user information for validating the payload object 158 associated with the interaction payload 160. The validation message 167 with the security code 170 may represent a request for validating whether the payload object 158 is sent by the first user 102 associated with the first user profile 152. The validation message 167 may include certain information to request the first user 102 to validate the payload object 158 associated with the interaction payload 160.

In one embodiment, the entity server 130 may execute the application 144 with the homomorphic encryption algorithm to generate an encrypted validation message 168 based on validation message 167 and the security code 170. When the entity server 130 determines that the encrypted interaction payload 166 is received from the second communication equipment 120, the entity server 130 may communicate the encrypted validation message 168 including a security code 170 through the second communication equipment 120 to the first communication equipment 110 through the network 180. When the entity server 130 determines that the encrypted interaction payload 166 is received from an intermediate equipment such as the fifth communication equipment 108, the entity server 130 may communicate the encrypted validation message 168 to the fifth communication equipment 108 through the network 180. The fifth communication equipment 108 may forward the encrypted validation message 168 through other intermediate equipment, such as the fourth communication equipment 106, the third communication equipment 104 and the second communication equipment 120 to the first communication equipment 110 along the dynamic hopping chain 210 as illustrated in FIG. 2.

In response to receiving the encrypted validation message 168, the first communication equipment 110 may execute the application 144 with the homomorphic encryption algorithm to obtain the validation message 167 with the security code 170 based on the encrypted validation message 168. If the validation message 167 with the security code 170 includes information to request the first user 102 to validate the payload object 158 associated the interaction payload 160. The first user 102 may operate the first communication equipment 110 to enter user input 172 with the security code 170 to confirm that the payload object 158 is associated the interaction payload 160. The first communication equipment 110 may execute the application 144 with the homomorphic encryption algorithm to generate the encrypted user input 174 based on the user input 172. The encrypted user input 174 includes the security code 170 that the user enters through the first communication equipment 110 to validate the payload object 158 associated with the interaction payload 160. The first communication equipment 110 may communicate to the second communication equipment 120 an encrypted user input 174 for validating the payload object 158 via the short-range wireless connection. The first communication equipment 110 may transfer the encrypted user input 174 through the second communication equipment 120 or other intermediate equipment along dynamic hopping chain 210 to the entity server 130.

In response to receiving the encrypted user input 174 through the second communication equipment 120 or another intermediate equipment, the entity server 130 may determine whether the user input 172 comprises the security code 170 included in the encrypted validation message 168. For example, the entity server 130 may execute the application 144 with the homomorphic encryption algorithm to determine the user input 172 based on the encrypted user input 174. The entity server 130 may execute the software instructions 142 to determine whether the user input 172 includes the security code 170 in the encrypted validation message 168. If the entity server 130 determines that the user input 172 includes the security code 170, the entity server 130 may reconcile the payload object 158 for the first user 102 to complete the interaction session based on the payload instruction 162 and the payload metadata 164. In some embodiments, the entity server 130 may reconcile the payload object 158 by sending the payload object 158 from the first user profile 152 to the third party server, such as a merchant. For example, the entity server 130 may send the payload object 158 indicative of a digital value from the first user profile 152 to the third party server based on the payload instruction 162 and the payload metadata 164. In another example, the entity server 130 may send the payload object 158 indicative of a digital document from the first user profile 152 to the third party server based on the payload instruction 162 and the payload metadata 164.

Example Operational Flow for Implementing an Interaction Session with an Entity Using Intermediate Equipment and Homomorphic Encryption

FIG. 3 illustrates an example flow of a method 300 for implementing an interaction session with an entity using intermediate equipment and homomorphic encryption in the system 100. Modifications, additions, or omissions may be made to method 300. Method 300 may include more, fewer, or other operations. For example, operations may be performed by the first communication equipment 110, the second communication equipment 120, and the entity server 130 in parallel or in any suitable order. While at times discussed as the system 100, processor 112, processor 122, processor 132, security engine 134 or components of any of thereof performing operations, any suitable system or components of the system 100 may perform one or more operations of the method 300. For example, one or more operations of method 300 may be implemented, at least by the first communication equipment 110, the second communication equipment 120, and the entity server 130 to perform operations 302-326.

The method 300 begins at operation 302 where a first communication equipment 110 associated with a first user 102 initiates an interaction session associated with an interaction payload 160 with a second communication equipment 120. The interaction payload 160 comprises a payload instruction 162 and a payload metadata 164 to send a payload object 158 to an entity. The payload metadata 164 of the interaction payload 160 may comprise the payload object 158, a first user identifier 154, a first user location, and entity information. The payload object 158 may be associated with a first user profile 152 and the first user identifier 154. The payload instruction 162 of the interaction payload 160 may represent or be associated with a request 146 that the first user 102 requests the entity to send the payload object 158 from the first user profile 152 to a third party server.

In some embodiments, the first communication equipment 110 may be communicatively coupled to the second communication equipment 120 via a short-range wireless connection. At operation 322, the first user 102 may use the first communication equipment 110 to send a request 146 to pair with the second communication equipment 120 located in an area of the short-range wireless connection. At operation 324, the second communication equipment 120 may execute the application 144 to process the request 146 to determine whether to approve the request 146. For example, the second communication equipment 120 may execute the application 144 to approve the request 146 when the second communication equipment 120 determines that both the first communication equipment 110 and the second communication equipment 120 use one or more application services provided by the entity server 130 associated with the entity. At operation 326, in response to receiving an approval from the second communication equipment 120, the first communication equipment 110 may establish a wireless connection with the second communication equipment 120 via the short-range wireless connection. The first communication equipment 110 may execute the application 144 with a homomorphic encryption algorithm to encrypt the interaction payload 160 as an encrypted interaction payload 166 based on the payload instruction 162 and the payload metadata 164. The method 300 may continue to operation 304 described below.

At operation 304, the first communication equipment 110 communicates the encrypted interaction payload 166 to the second communication equipment 120 via the short-range wireless connection, such as Bluetooth.

At operation 306, the second communication equipment 120 may execute the application 144 to receive the encrypted interaction payload 166 from the first communication equipment 110. The second communication equipment 120 may execute the application 144 to forward the encrypted interaction payload 166 to the entity server 130 associated with the entity through the network 180. For example, the second communication equipment may execute the application 144 to forward the encrypted interaction payload 166 to the entity server 130 without decrypting the encrypted interaction payload 166. Information related to the encrypted interaction payload 166 may be securely transmitted from the first communication equipment 110 to the entity server 130.

At operation 308, in response to receiving the encrypted interaction payload 166, the entity server 130 sends to the first communication equipment 110 through the second communication equipment 120 an encrypted validation message 168 to request the first user 102 to validate the payload object 158 associated with the interaction payload 160. In some embodiments, the entity server 130 may execute the application 144 to generate a validation message 167 and a security code 170. The entity server 130 may execute the application 144 with a homomorphic encryption algorithm to encrypt the validation message 167 and the security code 170 as the encrypted validation message 168. In some embodiments, the encrypted validation message 168 may include certain instructions to request the second communication equipment 120 to send the encrypted validation message 168 to the first user 102 for validating the payload object 158 associated with the interaction payload 160. The second communication equipment 120 may execute the application 144 to send the encrypted validation message 168 to the first communication equipment 110 associated with the first user 102 without decrypting the encrypted validation message 168. Information related to the encrypted validation message 168 may be securely transmitted from the entity server 130 to the first communication equipment 110.

At operation 310, in response to receiving the encrypted validation message 168 from the second communication equipment 120, the first communication equipment 110 may receive a user input 172 with the security code 170 from the first user 102 through the user interface 114. The first communication equipment 110 may execute the application 144 with the homomorphic encryption algorithm to obtain the validation message 167 and the security code 170 based on the encrypted validation message 168. For example, the first communication equipment may decrypt the encrypted validation message to obtain the security code. The first communication equipment 110 may present the security code 170 with the validation message 167 to the user interface 114 of the first communication equipment 110. The first user 102 may enter the security code 170 as the user input 172 through the user interface 114 of the first communication equipment 110 to validate the payload object 158 associated with the interaction payload 160. The first communication equipment 110 may execute the application 144 with the homomorphic encryption algorithm to encrypt the user input 172 including the security code 170 as an encrypted user input 174.

At operation 312, the first communication equipment 110 may communicate to the second communication equipment 120 the encrypted user input 174 validating the payload object 158 associated with the interaction payload 160 via the short-range wireless connection.

At operation 314, the second communication equipment 120 may execute the application 144 to forward the encrypted user input 174 to the entity server 130 without decrypting information of the encrypted user input 174 through the network 180.

At operation 316, the entity server 130 may execute the application 144 with the homomorphic encryption algorithm to determine the user input 172 based on the encrypted user input 174.

At operation 318, the entity server 130 may execute the software instructions 142 to determine whether the user input 172 comprises the security code 170. In response to determining that the user input 172 does not comprise the security code 170, the entity server 130 may reject to process the encrypted interaction payload 166 and terminate the interaction session with the second communication equipment 120. The entity server 130 may send a rejection message to the second communication equipment 120 to indicate that the user input 172 is invalid and the interaction payload 160 is rejected. The second communication equipment 120 may forward the rejection message to the first communication equipment 110.

At operation 320, in response to determining that the user input 172 comprises the security code 170, the entity server 130 may validate that the payload object 158 associated with the interaction payload 160 associated with the first user 102. The entity server 130 reconciles the payload object 158 based on the payload instruction 162 and the payload metadata 164 to complete the interaction session. In some embodiments, the entity server 130 may reconcile the payload object 158 by sending the payload object 158 from the first user profile 152 to the third party server to complete the interaction session.

The disclosed system is integrated into a practical application which improves the security and efficiency of the current payload transmission and validation process by using intermediate equipment and homomorphic encryption for a user 102 with a first communication equipment 110 which is not connected to the network 180.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, equipment, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system comprising:
a first communication equipment associated with a first user and communicatively coupled to a second communication equipment via a short-range wireless connection; and
the second communication equipment in communication with an entity server via a network,
wherein the first communication equipment is configured to:
initiate, by a first communication equipment associated with a first user, an interaction session associated with an interaction payload with a second communication equipment, wherein the first communication equipment is communicatively coupled to the second communication equipment via a short-range wireless connection, wherein the interaction payload comprises a payload metadata and a payload instruction to send a payload object to an entity, wherein the interaction payload is encrypted as an encrypted interaction payload;
communicate the encrypted interaction payload to the second communication equipment;
receive a user input to validate the interaction payload object associated with the interaction payload in response to an encrypted validation message from the second communication equipment;
communicate to the second communication equipment an encrypted user input validating the interaction payload object via the network;
wherein the second communication equipment is configured to:
forward the encrypted interaction payload to an entity server associated with the entity;
forward, by the second communication equipment, the encrypted user input to the entity server;
wherein the entity server is configured to:
in response to receiving the encrypted interaction payload, send to the first communication equipment through the second communication equipment, the encrypted validation message to validate the interaction payload object associated with the interaction payload, wherein the encrypted validation message comprises a security code;
determine the user input based on the encrypted user input;
determine whether the user input comprises the security code; and
reconcile the payload object based on the payload instruction and the payload metadata to complete the interaction session in response to determining that the user input comprises the security code.

2. The system of claim 1, wherein the first communication equipment is configured to:
send a request to pair with the second communication equipment located in an area of the short-range wireless connection; and
in response to receiving an approval from the second communication equipment, establish a wireless connection with the second communication equipment, wherein the second communication equipment is configured to determine whether to approve the request.

3. The system of claim 1, wherein the first communication equipment is configured to decrypt the encrypted validation message to obtain the security code.

4. The system of claim 1, wherein the second communication equipment is one of a plurality of communication equipment in a dynamic hopping chain, wherein the dynamic hopping chain is established based on an availability and a location of each communication equipment associated with the dynamic hopping chain; and
wherein the dynamic hopping chain is configured to:
transmit the encrypted interaction payload and the encrypted user input from the second communication equipment to the entity server along the dynamic hopping chain; and
transmit the encrypted validation message from the entity server to the second communication equipment to the first communication equipment along the dynamic hopping chain.

5. The system of claim 1, wherein:
the payload metadata of the interaction payload comprises the payload object, a first user identifier, a first user location, and entity information;
the payload object is associated with a first user profile and the first user identifier; and
the payload instruction of the interaction payload represents a payload request that the first user requests the entity to send the payload object from the first user profile to a third party server.

6. The system of claim 1, wherein reconciling the payload object by the entity server further comprises sending the payload object to a third party server.

7. The system of claim 1, wherein:
a common application is installed on the first communication equipment, the second communication equipment, and the entity server; and
the common application is configured to implement homomorphic encryption.

8. A method comprising:
initiating, by a first communication equipment associated with a first user, an interaction session associated with an interaction payload with a second communication equipment, wherein the first communication equipment is communicatively coupled to the second communication equipment via a short-range wireless connection, wherein the interaction payload comprises a payload metadata and a payload instruction to send a payload object to an entity, wherein the interaction payload is encrypted as an encrypted interaction payload;
communicating, by the first communication equipment, the encrypted interaction payload to the second communication equipment;
forwarding, by the second communication equipment, the encrypted interaction payload to an entity server associated with the entity;
in response to receiving the encrypted interaction payload, sending to the first communication equipment, by the entity server through the second communication equipment via a network, an encrypted validation message to validate the interaction payload object associated with the interaction payload, wherein the encrypted validation message comprises a security code;
receiving, by the first communication equipment, a user input to validate the interaction payload object associated with the interaction payload in response to the encrypted validation message;
communicating to the second communication equipment, by the first communication equipment, an encrypted user input validating the interaction payload object;
forwarding, by the second communication equipment, the encrypted user input to the entity server via the network;
determining, by the entity server, the user input based on the encrypted user input;
determining, by the entity server, whether the user input comprises the security code; and
reconciling, by the entity server, the payload object based on the payload instruction and the payload metadata to complete the interaction session in response to determining that the user input comprises the security code.

9. The method of claim 8, further comprising:
sending, by the first communication equipment, a request to pair with the second communication equipment located in an area of the short-range wireless connection;
determining, by the second communication equipment, whether to approve the request; and
in response to receiving an approval from the second communication equipment, establishing, by the first communication equipment, a wireless connection with the second communication equipment.

10. The method of claim 8, further comprising:
decrypting, by the first communication equipment, the encrypted validation message to obtain the security code.

11. The method of claim 8, wherein the second communication equipment is one of a plurality of communication equipment in a dynamic hopping chain, wherein the dynamic hopping chain is established based on an availability and a location of each communication equipment associated with the dynamic hopping chain; and
wherein the dynamic hopping chain is configured to:
transmit the encrypted interaction payload and the encrypted user input from the second communication equipment to the entity server along the dynamic hopping chain; and
transmit the encrypted validation message from the entity server to the second communication equipment to the first communication equipment along the dynamic hopping chain.

12. The method of claim 8, wherein:
the payload metadata of the interaction payload comprises the payload object, a first user identifier, a first user location, and entity information;
the payload object is associated with a first user profile and the first user identifier; and
the payload instruction of the interaction payload represents a payload request that the first user requests the entity to send the payload object from the first user profile to a third party server.

13. The method of claim 8, wherein reconciling the payload object by the entity server further comprises sending the payload object to a third party server.

14. The method of claim 8, wherein:
a common application is installed on the first communication equipment, the second communication equipment, and the entity server; and
the common application is configured to implement homomorphic encryption.

15. A method comprising:
initiating, by a first communication equipment associated with a first user, an interaction session associated with an interaction payload with a second communication equipment, wherein the first communication equipment is communicatively coupled to the second communication equipment via a short-range wireless connection, wherein the interaction payload comprises a payload metadata and a payload instruction to send a payload object to an entity, wherein the interaction payload is encrypted as an encrypted interaction payload;
communicating, by the first communication equipment, the encrypted interaction payload to the second communication equipment;
forwarding, by the second communication equipment, the encrypted interaction payload to an entity server associated with the entity via a network;
in response to receiving the encrypted interaction payload, sending to the first communication equipment, by the entity server through the second communication equipment via the network, an encrypted validation message to validate the interaction payload object associated with the interaction payload, wherein the encrypted validation message comprises a security code;
receiving, by the first communication equipment, a user input to validate the interaction payload object associated with the interaction payload in response to the encrypted validation message;
communicating to the second communication equipment, by the first communication equipment through the second communication equipment, an encrypted user input validating the interaction payload object;
determining, by the entity server, whether the user input comprises the security code based on the encrypted user input; and
reconciling, by the entity server, the payload object based on the payload instruction and the payload metadata to complete the interaction session in response to determining that the user input comprises the security code.

16. The method of claim 15, further comprising:
sending, by the first communication equipment, a request to pair with the second communication equipment located in an area of the short-range wireless connection;
determining, by the second communication equipment, whether to approve the request; and
in response to receiving an approval from the second communication equipment, establishing, by the first communication equipment, a wireless connection with the second communication equipment.

17. The method of claim 15, further comprising:
decrypting, by the first communication equipment, the encrypted validation message to obtain the security code.

18. The method of claim 15, wherein the second communication equipment is one of a plurality of communication equipment in a dynamic hopping chain, wherein the dynamic hopping chain is established based on an availability and a location of each communication equipment associated with the dynamic hopping chain; and
wherein the dynamic hopping chain is configured to:
transmit the encrypted interaction payload and the encrypted user input from the second communication equipment to the entity server along the dynamic hopping chain; and
transmit the encrypted validation message from the entity server to the second communication equipment to the first communication equipment along the dynamic hopping chain.

19. The method of claim 15, wherein:
the payload metadata of the interaction payload comprises the payload object, a first user identifier, a first user location, and entity information;
the payload object is associated with a first user profile and the first user identifier; and
the payload instruction of the interaction payload represents a payload request that the first user requests the entity to send the payload object from the first user profile to a third party server.

20. The method of claim 15, wherein:
reconciling the payload object by the entity server further comprises sending the payload object to a third party server; and
wherein a common application is installed on the first communication equipment, the second communication equipment, and the entity server; and
wherein the common application is configured to implement homomorphic encryption.
